(19) United States
(12) Patent Application Publication
(10) Pub. No.: US 2026/0239454 A1
(43) Pub. Date: Aug. 13, 2026

(54) TECHNOLOGIES FOR IDENTIFYING ENHANCED REDUCED CAPABILITY USER EQUIPMENT IN WIRELESS NETWORKS

(71) Applicant: Apple Inc., Cupertino, CA (US)

(72) Inventors: Naveen Kumar R. Palle Venkata, San Diego, CA (US); Peng Cheng, Beijing (CN); Ralf Rossbach, Munich (DE); Haijing Hu, Los Gatos, CA (US); Hong He, San Jose, CA (US); Zhibin Wu, Los Altos, CA (US); Yuqin Chen, Beijing (CN); Fangli Xu, Beijing (CN); Ping-Heng Kuo, London (GB)

(73) Assignee: Apple Inc., Cupertino, CA (US)

(21) Appl. No.: 19/156,391

(22) PCT Filed: Feb. 14, 2023
(86) PCT No.: PCT/CN2023/075984

§ 371 Date: Aug. 13, 2025

(51) Int. Cl. H04W 74/0838; H04W 72/1263

(52) U.S. Cl. CPC H04W 74/0838; H04W 72/1263

(57) ABSTRACT

The present application relates to devices and components including apparatus, systems, and methods for identifying enhanced reduced capability user equipment in wireless networks.

### TECHNICAL FIELD

This application relates generally to communication networks and, in particular, to technologies for identifying and managing enhanced reduced capability user equipment in wireless networks.

### BACKGROUND

Reduced-capability (RedCap) devices may be used in Third Generation Partnership Project (3GPP) networks. These RedCap devices may be used for industrial wireless sensors, video surveillance, or wearable devices. With respect to non-RedCap devices, RedCap devices may have less receive/transmit antennas, reduced bandwidth, half-duplex frequency division duplexing (instead of full-duplex), relaxed UE processing time, and relaxed UE processing capability.

### BRIEF DESCRIPTION OF THE DRAWINGS

FIG. 1 illustrates a network environment in accordance with some embodiments.

FIG. 2 illustrates a signaling diagram in accordance with some embodiments.

FIG. 3 illustrates configuration of bandwidth parts in accordance with some embodiments.

FIG. 4 illustrates a signaling diagram in accordance with some embodiments.

FIG. 5 illustrates an operational flow/algorithmic structure in accordance with some embodiments.

FIG. 6 illustrates an operational flow/algorithmic structure in accordance with some embodiments.

FIG. 7 illustrates a user equipment in accordance with some embodiments.

FIG. 8 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

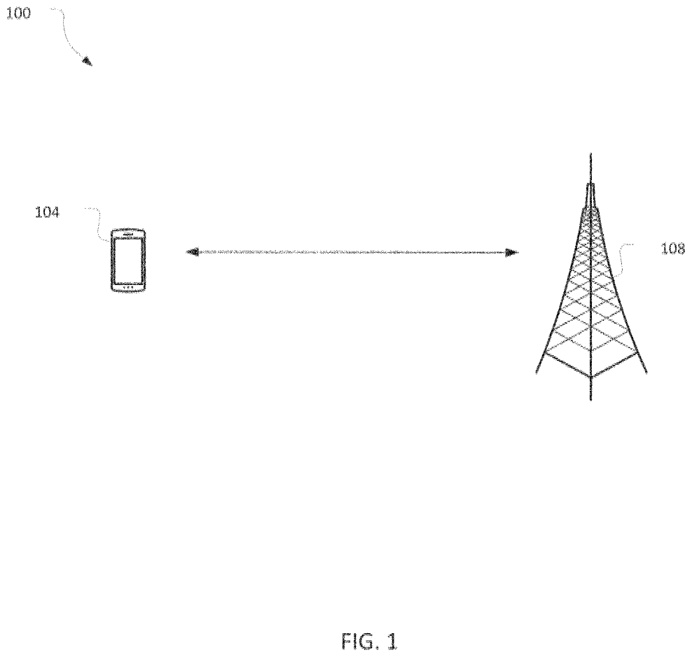

FIG. 1 illustrates a network environment 100 in accordance with some embodiments. The network environment 100 may include a UE 104 and a base station 108. The base station 108 may provide one or more wireless access cells through which the UE 104 may communicate with the base station 108. The base station 108 may provide an air interface compatible with 3GPP technical specifications, such as those that define Fifth Generation (5G) new radio (NR) or later system standards. The base station 108 may provide the UE 104 access to other networks, for example, a 3GPP core network, a data network, etc. Depending on the technology of the access and core network, the base station may be referred to as an eNB, gNB, an ng-NB, etc.

The UE 104 may engage the base station 108 through a random access (RA) procedure. The RA procedure may be triggered based on a number events including, for example, initial access from a radio resource control (RRC) idle state, RRC connection reestablishment or resume procedure, small data transmissions in an RRC inactive state, etc. The RA procedure may be a 4-step RA type or a 2-step RA type. Either the 4-step RA type or the 2-step RA type may use contention-based random access (CBRA) or contention-free random-access (CFRA). In general, the RA procedure may be similar to that described in 3GPP 38.300 v17.3.0 (2023 Jan. 13) except as otherwise described herein.

In order to reduce device complexity and energy consumption, Release 17 3GPP networks include provisions for reduced capability (RedCap) UEs. These RedCap UEs have less transmit/receive capabilities as compared to the non-RedCap UEs. For example, a RedCap UE may have a reduced number of receive/transmit antennas (for example, less than four), UE bandwidth reduction (for example, up to 20 MHz), half-duplex frequency division duplexing, a relaxed UE processing time, or a relaxed UE processing capability.

To enable further reduction of device complexity and energy consumption, enhanced reduced capability (eRedCap) UEs may be provided with further reduced complexity as compared to RedCap UEs. For example, an eRedCap UE operating in frequency range 1 (FR1) may be provided further UE baseband bandwidth reduction and UE peak data rate reduction.

The baseband bandwidth reduction may restrict the eRedCap UE to a baseband bandwidth no greater than 5 MHz for physical downlink shared channel ((PDSCH) transmissions (both unicast and broadcast) and physical uplink shared channel (PUSCH) transmissions. The radio-frequency (RF) bandwidth for uplink and downlink may be larger, for example, 20 MHz (similar to RedCap UEs). Further, other physical channels in signals may still be allowed to use a bandwidth part (BWP) up to a 20 MHz maximum UE RF plus baseband bandwidth.

A RedCap UE may have a constraint (vLayers*Qm*f>4) for peak data rate reduction, where vLayers is a number of transmission layers, Qm is a modulation order, and f is a scaling factor. An eRedCap UE may relax this constraint be vLayers*Qm*f>1.

An eRedCap UE may operate with either 15 kilohertz (kHz) subcarrier spacing (SCS) or 30 kHz SCS.

In some embodiments, only one type of eRedCap UE may be defined. This may further reduce UE complexity. However, in other embodiments, more than type of eRedCap UE may be defined.

To facilitate incorporation of eRedCap UEs into new cellular networks (for example, networks operating consistent with 3GPP Release 18 and later TSs), an existing UE capability framework may be used. Changes to capability signaling may be specified as needed. However, by default, all UE capabilities applicable to a RedCap UE as defined by 3GPP R17 TSs may be applicable to eRedCap UEs unless otherwise specified.

If the UE 104 is an eRedCap UE, which may be assumed for purposes of the embodiments described herein, the base station 108 may need to restrict scheduling of PUSCH/PDSCH transmissions on physical resource block (PRB) allocations that do not exceed 5 MHz. This restriction may even apply during the RA procedure, for example, with respect to a message 3 (Msg3) PUSCH. However, in legacy networks, information about the capabilities of a UE (including RedCap capabilities) are not transferred to the network until a much later time. Typically, a UE will camp on a cell, perform an RA procedure, enter into connected mode, receive downlink control information (DCI) that schedules resources for the UE to transmit uplink registration information, and then engage in a UE capability request response.

Embodiments of the present disclosure provide signaling in the RA procedure to inform the base station 108 that the UE 104 is an eRedCap UE. This may allow the base station 108 to ensure that subsequent scheduling does not exceed the limited capabilities of the UE 104.

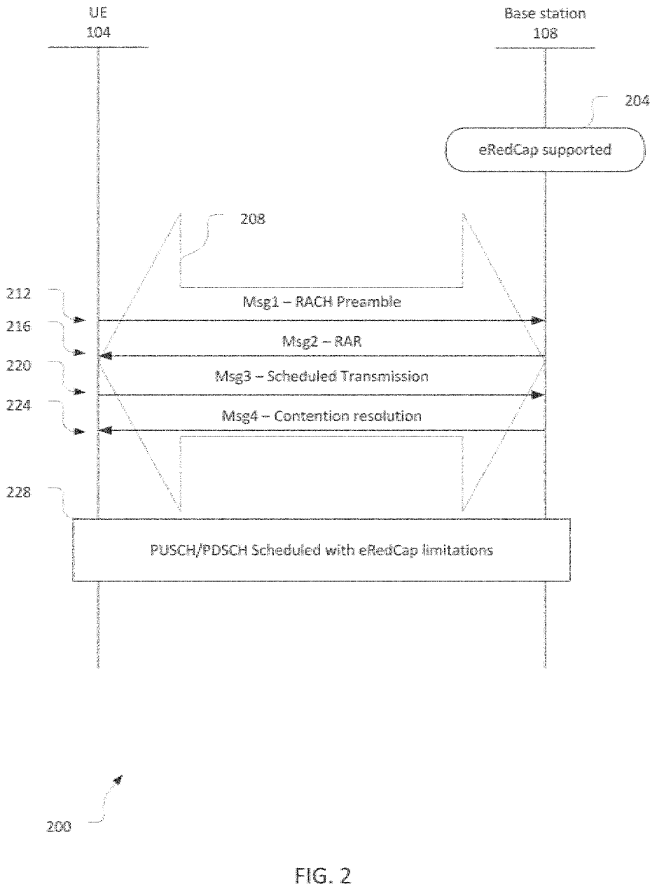

FIG. 2 illustrates a signaling operation 200 in accordance with some embodiments. In the signaling operation 200, the UE 104 may inform the base station 108 that the UE 104 is operating as an eRedCap UE.

The signaling operation 200 may include, at 204, the base station 108 supporting eRedCap. In some embodiments, the base station 108 may send a broadcast transmission that indicates support of eRedCap for one or more cells provided by the base station 108.

The signaling operation 200 may further include an RA procedure 208. The RA procedure 208 may be a 4-step RA type using CBRA.

The RA procedure 208 may include, at 212, the UE 104 transmitting a first message (Msg1) to the base station 108. The Msg1 may include an RA preamble transmitted on physical random access channel (PRACH) resources. The RA preamble may be randomly selected from a pool of shared RA preambles. At 216, the RA procedure may include the base station 108 responding to the Msg1 by transmitting a random-access response (RAR) in a second message (Msg2). The RAR may include an RA preamble identifier, timing alignment information, initial uplink grant, and temporary cell—radio network temporary identifier (TC-RNTI). If the UE 104 receives a PDCCH with the RAR within a defined time window, and the RAR includes a preamble identifier that corresponds to the preamble transmitted in Msg1, the response is successful. The RA procedure 208 may then include the UE 104 sending a scheduled uplink transmission over a PUSCH in a third message (Msg3). The third message may include an ID for contention resolution. In a fourth step, the base station 108 may send the contention resolution ID in a fourth message (Msg4) at 224. If the UE 104 properly decodes the contention resolution ID, the RA procedure 208 may complete.

In the event the RA procedure 208 was a CFRA, the network may assign the UE 104 with RA preambles dedicated to the UE 104. These dedicated RA preambles may be transmitted in a RA preamble assignment message. Thus, the contention resolution of Msg4 may not be needed.

The UE 104 may use the RA procedure to indicate that it is an eRedCap UE. The base station 108 may then use this information to schedule uplink and downlink shared channels (e.g., PUSCH/PDSCH) within eRedCap limitations at 228. This may be done by, e.g., restricting the scheduled PRBs to have a bandwidth of 5 MHz or less. This restriction may be imposed at least until the UE 104 provides a more complete set of eRedCap capabilities to the base station 108 at a later time.

The UE 104 may use the RA procedure 208 to indicate that it is an eRedCap UE in accordance with one or more of the following options. These options may be used in conjunction with one another or independently. While some combinations of these options are specifically described, other combinations may also be used in various embodiments.

In a first option, the UE 104 may include an eRedCap indication in a MAC control element (CE) that is included in the Msg3 transmitted at 220. In some embodiments, the eRedCap indication may be a value indicated in a logical channel identifier (LCID) field of the MAC CE. For example, Table 6.2.1-2 Values of LCID for UL-SCH of 3GPP TS 38.321 v17.3.0 2023-01-13 may be modified as shown below in Table 1, with the portions struck through removed and the portions underlined added to accommodate the eRedCap indication.

TABLE 1

| Codepoint/Index | LCID values |
|---|---|
| 0 | CCCH of size 64 bits (referred to as “CCCH1” |
| | in TS 38.331 [5]), except for a RedCap UE |
| | or an eRedCap UE |
| 1-32 | Identity of the logical channel of DCCH and DTCH |
| 33 | Extended logical channel ID field (two-octet eLCID |
| | field) |
| 34 | Extended logical channel ID field (one-octet eLCID |
| | field) |
| 35 | CCCH of size 48 bits (referred to as “CCCH” |
| | in TS 38.331 [5]) for aRedCap UE |
| | or an eRedCap UE |
| 36 | CCCH of size 64 bits (referred to as “CCCH1” |
| | in TS 38.331 [5]) for a RedCap UE |
| | or an eRedCap UE |
| 37 | CCCH of size 48 bits (referred to as “CCCH” |
| | in TS 38.331 [5]) for an eRedCap UE, which |
| | cannot support more than 5 MHz for UL SCH |
| 38 | CCCH of size 64 bits (referred to as “CCCH1” |
| | in TS 38.331 [5]) for an eRedCap UE, which |
| | cannot support more than 5 MHz for UL SCH |
| [symbol] 39-42 | Reserved |
| 43 | Truncated Enhanced BFR (one octet Cᵢ) |
| 44 | Timing Advance Report |
| 45 | Truncated Sidelink BSR |
| 46 | Sidelink BSR |
| 47 | Reserved |
| 48 | LBT failure (four octets) |
| 49 | LBT failure (one octet) |
| 50 | BFR (one octet Cᵢ) |
| 51 | Truncated BFR (one octet Cᵢ) |
| 52 | CCCH of size 48 bits (referred to as “CCCH” in |
| | TS 38.331 [5]), except for a RedCap UE |
| | or an eRedCap UE |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

Thus, the UE 104 may include a value corresponding to codepoint/index 37 if the size of the UL CCCH MAC service data unit (SDU) of Msg3 that carries the LCID is 48 bits or a value corresponding to codepoint/index 38 if the size of the UL CCCH MAC SDU of Msg3 that carries the LCID is 64 bits. In either case, the base station 108 would understand that the UE 104 is operating as an eRedCap UE and should not be scheduled with an UL/DL shared channel more than 5 MHz.

In some embodiments, the modification to codepoints 35/36 would only be included if the modifications to 37/38 are not added. This may be the case if the base station 108 supports both RedCap and eRedCap and plans to schedule defensively even for RedCap (until the actual capabilities are received). In other embodiments, the modifications to codepoints 35/36 would be added with the modifications to 37/38. This may allow a legacy base station, that does not implement the updated eRedCap, to treat an eRedCap UE as a RedCap UE and not handle the UE. Base stations that have implemented the update eRedCap may additionally look to the 37/38 codepoints to determine whether the UE is a RedCap or eRedCap UE. If a base station only supports RedCap and not eRedCap, an eRedCap may not camp on its cell.

In a second option for using the RA procedure 208 to indicate that the UE 104 is an eRedCap UE, the UE 104 may transmit the Msg1 using a RACH partition that the network configures for eRedCap UEs.

RACH partitioning may be accomplished by the network associating a set of RACH resources with one or more features. The set of RACH resources will only be valid for RA procedures having the associated features. In some embodiments, eRedCap operation may be a feature that can be associated with a set of RACH resources. A set of RACH resources, which may also be referred to as a RACH partition, may include RA preambles.

In some embodiments, the network may configure the RACH partition for eRedCap UEs using a feature combination (FeatureCombination) information element (IE). The FeatureCombination IE may be used to indicate a feature or combination of features to be associated with a set of RA resources (e.g., an instance of a feature combination preambles (FeatureCombinationPreambles) IE). Abstract syntax notation 1 (ASN1) code for a FeatureCombination IE that enables configuration of a RACH partition for the eRedCap UEs is as follows.

-- ASN1START

-- TAG-FEATURECOMBINATION-START
FeatureCombination-r17 ::= SEQUENCE {

| | | |
|---|---|---|
| redCap-r17 | ENUMERATED {true} | OPTIONAL, -- Need R |
| smallData-r17 | ENUMERATED {true} | OPTIONAL, -- Need R |
| nsag-r17 | NSAG-List-r17 | OPTIONAL, -- Need R |
| msg3-Repetitions-r17 | ENUMERATED {true} | OPTIONAL, -- Need R |
| eRedCap-r18 | ENUMERATED {true} | OPTIONAL, -- Need R |
| spare3 | ENUMERATED {true} | OPTIONAL, -- Need R |
| spare2 | ENUMERATED {true} | OPTIONAL, -- Need R |
| spare1 | ENUMERATED {true} | OPTIONAL -- Need R |
| } | | |

NSAG-List-r17 ::= SEQUENCE (SIZE (1.. maxSliceInfo-r17)) OF NSAG-ID-r17
-- TAG-FEATURECOMBINATION-STOP

-- ASN1STOP

Presence of the eRedCap value in the FeatureCombination IE indicates that eRedCap is part of a feature combination associated with the RACH partition.

The FeatureCombinationPreambles IE associates a set of preambles with a feature combination. The ASN1 code for a FeatureCombinationPreambles IE that enables configuration of a RACH partition for the eRedCap UEs is as follows.

-- ASN1START

-- TAG-FEATURECOMBINATIONPREAMBLES-START
FeatureCombinationPreambles-r17 ::= SEQUENCE {

| | |
|---|---|
| featureCombination-r17 | FeatureCombination-r17, |
| startPreambleForThisPartition-r17 | INTEGER (0..63), |

numberOfPreamblesPerSSB-ForThisPartition-r17 INTEGER (1..64),

| | | |
|---|---|---|
| ... | | |
| deltaPreamble-r17 | INTEGER (−1..6) | OPTIONAL, -- |
| Need R | | |
| ... | | |
| } | | |

Except as otherwise noted, the FeatureCombination IE and the FeatureCombinationPreambles IE may be similar to those defined in 3GPP TS 38.331 v17.3.0 (2022 December).

In some embodiments, separate RACH partitions may be configured for RedCap UEs and eRedCap UE. For example, a first RACH partition may be configured for, and used by, RedCap UEs and a second RACH partition may be configured for, and used by, eRedCap UEs. Referring again to FIG. 2, the RA preamble of the Msg1 transmission at 212 may be selected from the second RACH partition. The base station 108 may then determine, upon receiving the RA preamble, that the UE 104 is operating as an eRedCap UE. In some instances, the UE 104 may also send another eRedCap indication in the Msg 3 transmission at 220 (e.g., by selecting an LCID associated with eRedCap). In other instances, no additional eRedCap indication may be provided in the Msg3 transmission at 220.

In some embodiments, one RACH partition may be configured for, and used by, both RedCap UEs and eRedCap UEs. This may be enabled by providing configurations in which both RedCap UEs and eRedCap UEs are configured to use the same RACH configuration (e.g., one featureCombination configuration). In these embodiments, with all types of UEs having reduced capabilities using this RACH configuration, it may be advantageous to additionally include the eRedCap indication in the Msg 3 transmission at 220 to enable further differentiation.

In some embodiments, the network (e.g., the base station 108) may instruct the UE 104 to use Msg1-based indication (e.g., using RA preamble of a RACH partition configured for eRedCap UEs), a Msg3-based indication (e.g., using an LCID that conveys the eRedCap indication), or both Msg1-based indication and Msg3-based indication.

In some embodiments, the network may provide the instruction to use Msg1/Msg3-based indication through the RACH partition configuration (e.g., the FeatureCombination IE and the FeatureCombinationPreambles IE). Additionally/alternatively, the network may provide the instruction to use Msg1/Msg3-based indication through a broadcast message such as, for example, a system information broadcast 1 (SIB1) transmission. The ASN1 code for a SIB1 that enables the network to instruct UEs to provide eRedCap indication may be provided as follows.

| SIB1-v1700-IEs ::= SEQUENCE { | | |
|---|---|---|
| hsdn-Cell-r17 | ENUMERATED {true} | OPTIONAL, -- Need R |
| uac-BarringInfo-v1700 | SEQUENCE { | |
| uac-BarringInfoSetList-v1700 | UAC-BarringInfoSetList-v1700 | |
| } | OPTIONAL, -- Cond MINT | |
| sdt-ConfigCommon-r17 SDT-ConfigCommonSIB-r17 | | OPTIONAL, -- Need R |
| redCap-ConfigCommon-r17 | RedCap-ConfigCommonSIB-r17 | |
| OPTIONAL, -- Need R | | |
| ... | | |
| nonCriticalExtension | SIB1-v1800-IEs | OPTIONAL |
| } | | |
| SIB1-v1800-IEs ::= SEQUENCE { | | |
| eRedCapSupport-r18 | ENUMERATED | {allowed} OPTIONAL, -- Need R |
| nonCriticalExtension | | SEQUENCE { } optional |
| } | | |

The base station 108 may use the SIB1 to indicate that the network supports eRedCap. The indication of network support for eRedCap may imply that the UE 104 can use the same RACH partition used by RedCap UEs and further differentiation may be provided by using LCID of a Msg 3 transmission.

Except as otherwise noted, the SIB1 may be similar to that defined in 3GPP TS 38.331.

In embodiments in which there is no indication in the RACH partition for eRedCap, but the SIB1 indicates the network supports eRedCap, the UE 104 may use the Msg3-based indication rather than the Msg1-based indication.

In some embodiments, instead of relying on the RACH partitioning framework to provide the eRedCap indication, as described above, separate PRACH resources may be configured for the eRedCap indication. The UE 104 will use the eRedCap-specific PRACH resources for the RA procedure 208 to indicate that it is operating as an eRedCap UE. In particular, the eRedCap-specific PRACH resources may be used for the Msg1 transmission at 212.

The eRedCap-specific PRACH resources may be configured without using the feature combination resources defined for the RACH partitions. Instead, the eRedCap-specific PRACH resources may be configured using a BWP configuration. For example, a BWP uplink common (BWP-UplinkCommon) IE, which is used to configure the common parameters of an uplink BWP, may be modified to configure eRedCap-specific PRACH resources as follows.

| | |
|---|---|
| BWP-UplinkCommon ::= SEQUENCE { | |
| genericParameters | BWP, |
| rach-ConfigCommon | SetupRelease { RACH- |
| ConfigCommon } | ... |
| [[ | |
| rach-ConfigCommonIAB-r16 | SetupRelease { RACH-ConfigCommon } |
| OPTIONAL, -- Need M | |
| useInterlacePUCCH-PUSCH-r16 | ENUMERATED {enabled} |
| OPTIONAL, -- Need R | |
| msgA-ConfigCommon-r16 | SetupRelease { MsgA-ConfigCommon-r16 } |
| OPTIONAL -- Cond SpCellOnly2 | |
| ]], | |
| [[ | |

enableRA-PrioritizationForSlicing-r17 BOOLEAN OPTIONAL, -- Cond RA-PrioSliceAI

| | |
|---|---|
| additionalRACH-ConfigList-r17 | SetupRelease { AdditionalRACH-ConfigList-r17 } |
| OPTIONAL, -- Cond SpCellOnly2 | |
| rsrp-ThresholdMsg3-r17 RSRP-Range | OPTIONAL, -- Need R |

numberOfMsg3-RepetionsList-r17 SEQUENCE (SIZE(4)) OF NumberOfMsg3-

| | |
|---|---|
| Repetitions-r17 OPTIONAL, -- Cond Msg3Rep | |
| msgA-ConfigCommon-r17 | SEQUENCE (SIZE(8)) OF INTEGER (0..31) |
| OPTIONAL -- Cond Msg3Rep | |
| ]] | |
| [[ | |

rach-ConfigCommonE-redCap-r18 SetupRelease {RACH ConfigCommon}

```
    } OPTIONAL, -- Need M
  ]]
}
```

The rach-ConfigCommonE-RedCap-r18 IE may indicate this BWP is configured specifically for eRedCap UEs. Thus, when the UE 104 performs the RA procedure in this BWP, the base station 108 may understand it is an eRedCap UE.

Except as otherwise noted, the BWP-UplinkCommon IE may be similar to that defined in 3GPP TS 38.331 v17.3.0 (2022 December).

In some embodiments, the eRedCap-specific PRACH resources may be a feature that is not combined with other features related to eRedCap identification. In other embodiments, the eRedCap-specific PRACH resources may be combined with other eRedCap identification features. For example, in some embodiments the UE 104 may use the eRedCap-specific PRACH resources in conjunction with the Msg3-based identification.

In some embodiments, the UE 104 may use the Msg3 transmission to indicate whether it is configured to use eRedCap-specific PRACH resources.

In other embodiments, the UE 104 may not be required to use the Msg3 transmission to indicate whether it is configured to use the eRedCap-specific PRACH resources. In these embodiments, one or more of the following options may be used. In a first option, the UE 104 may still use the LCID values of RedCap UEs from R17 (e.g., codepoints 35 or 36 from Table (without proposed modifications)). In a second option, the UE 104 may use a legacy LCID values that do not correspond to UEs having any form of reduced capabilities.

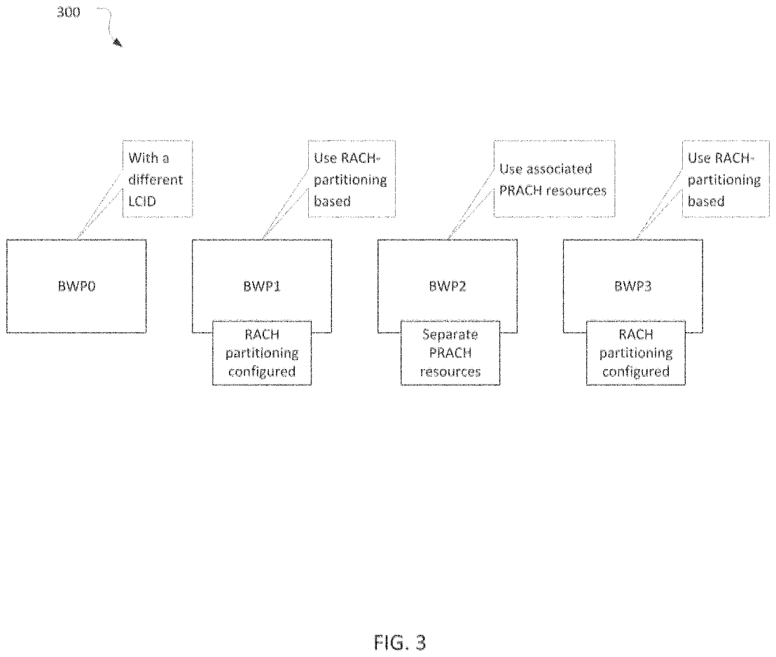

FIG. 3 illustrates BWP configurations 300 in which different BWPs are configured with different eRedCap notification procedures in accordance with some embodiments.

RACH partitioning configurations may be BWP specific. Thus, certain BWPs may be configured with RACH partitions that may be used for eRedCap identification. As shown in BWP configurations 300, BWP1 and BWP3 may have eRedCap partitions configured. If the UE 104 operates in either of these BWPs, it may use the RACH partitioning-based method for eRedCap identification.

If the UE 104 operates in a BWP that does not have RACH partitioning configured for eRedCap identification, the UE 104 may fall back to using other procedures for eRedCap identification. For example, if the UE 104 is operating in BWP0, which is configured to use a Msg3-based eRedCap identification, the UE 104 may use an eRedCap-specific LCID in Msg3 to provide the eRedCap identification. If the UE 104 is operating in BWP2, which is configured to use separate PRACH resources, the UE 104 may use the eRedCap-specific PRACH resources for eRedCap identification.

While not explicitly shown, a BWP may be configured with more than one eRedCap identification procedure.

In various embodiments, some eRedCap identification procedures may be preferred over others. For example, in one embodiment, RACH partitioning may be the preferred eRedCap identification procedure. Thus, if a BWP is configured with both eRedCap-specific PRACH resources and RACH partitioning, the UE 104 would use the RACH partitioning and not the eRedCap-specific PRACH resources for the eRedCap identification. In other embodiments, other eRedCap identification procedures may be preferred.

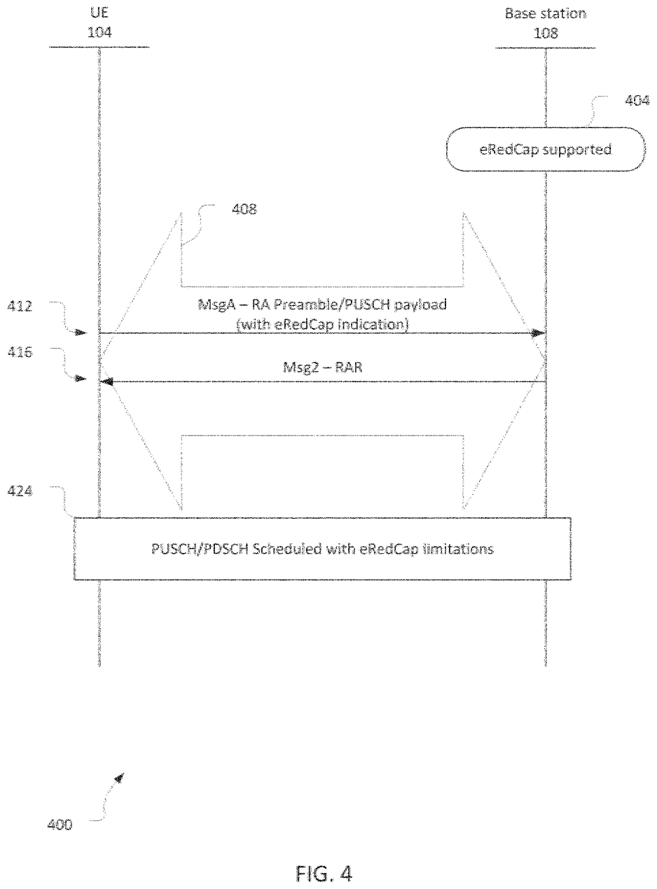

FIG. 4 illustrates a signaling operation 200 in accordance with some embodiments. In the signaling operation 400, the UE 104 may inform the base station 108 that the UE 104 is operating as an eRedCap UE using a two-step RA procedure 408.

The signaling operation 400 may include, at 404, the base station 108 supporting eRedCap. In some embodiments, the base station 108 may send a broadcast transmission that indicates support of eRedCap for one or more cells provided by the base station 108.

The RA procedure 408 may include, at 412, the UE 104 transmitting a first message (MsgA) to the base station 108. The MsgA transmission may include an RA preamble and a PUSCH transmission. Thus, MsgA represents a combination of Msg1 and Msg3 of the four-step procedure described in FIG. 2. At 416, the base station 108 may respond with a second message (MsgB) that includes both random access response and contention resolution content. Thus, MsgB represents a combination of Msg2 and Msg4 of the four-step procedure described in FIG. 2.

The UE 104 may use the RA procedure 408 to indicate it is operating as an eRedCap UE in any manner similar to that described above. For example, the UE 104 may include a MAC CE having the eRedCap indication in an LCID in the PUSCH payload of the MsgA transmission, it may select an RA preamble from a RACH partition configured for eRedCap UEs, or it may utilize eRedCap-specific PRACH resources for the RA procedure 408.

The base station 108, upon determining the UE 104 is an eRedCap UE through one or more of the indication mechanisms of the RA procedure 408, may schedule uplink and downlink shared channels (e.g., PUSCH/PDSCH) within eRedCap limitations at 424. This may be done by, e.g., restricting the scheduled PRBs to have a bandwidth of 5 MHz or less. This restriction may be imposed at least until the UE 104 provides a more complete set of eRedCap capabilities to the base station 108 at a later time.

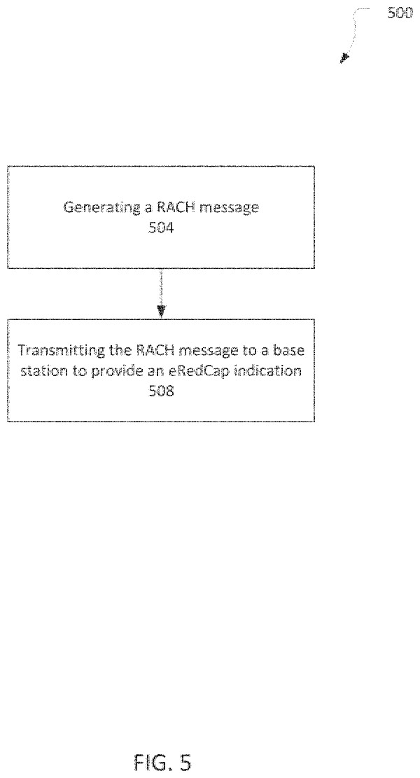

FIG. 5 illustrates an operational flow/algorithmic structure 500 for eRedCap identification in accordance with some embodiments. The operational flow/algorithmic structure 500 may be implemented by a UE such as, for example, UE 104 or 700 or components therein, for example, processing circuitry 704.

The operational flow/algorithmic structure 500 may include, at 504, generating a RACH message. The RACH message may be a message from a 4-step RA procedure (e.g., Msg1 or Msg3) or from a 2-step RA procedure (e.g., MsgA). The RACH message may be part of a CBRA procedure or a CFRA procedure.

The operational flow/algorithmic structure 500 may further include, at 508, transmitting the RACH message to a base station. The transmission of the RACH message may provide an indication to the base station that the UE is an eRedCap UE having a UL SCH bandwidth no greater than 5 MHz.

In some embodiments, the eRedCap indication may be included in the content of the RACH message. For example, the RACH message may include a PUSCH transmission with the eRedCap indication. This may be provided by a value of an LCID field of a MAC CE as described elsewhere herein. The LCID value may indicate that the UE is operating as the eRedCap UE and may additional indicate a CCCH has a size of 48 bits or 64 bits.

In some embodiments, the eRedCap indication may be provided by the nature of the RACH message itself. For example, the UE may be configured with RACH resources that are to be used by eRedCap UEs. In some embodiments, the RACH resources may be a RACH partition that is configured by a FeatureCombination IE and FeatureCombinationPreambles IE. The RACH partition may include a plurality of RA preambles that are to be used by eRedCap UEs. The UE 104 may provide the eRedCap indication by selecting one of the RA preambles for inclusion in the Msg1 or MsgA transmission.

In some embodiments, the RACH resources may be PRACH resources that are configured by a BWP-UplinkCommon IE specifically for eRedCap UEs. The UE 104 may provide the eRedCap indication by transmitting the RACH message on the eRedCap-specific PRACH resources.

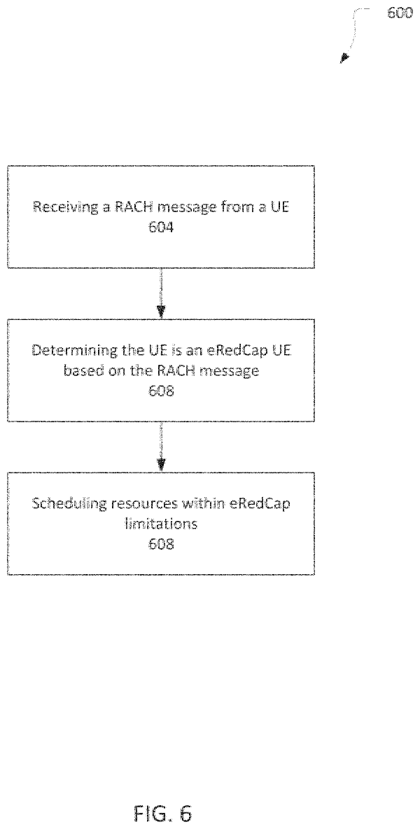

FIG. 6 illustrates an operational flow/algorithmic structure 600 for eRedCap indication in accordance with some embodiments. The operational flow/algorithmic structure 600 may be implemented by a base station such as, for example, base station 108 or network node 800 or components therein, for example, processing circuitry 804.

The operational flow/algorithmic structure 600 may include, at 604, receiving a RACH message from a UE. The RACH message may be part of a 2-step or 4-step RA procedure that may be a CBRA or a CFRA process.

The operational flow/algorithmic structure 600 may further include, at 608, determining the UE is an eRedCap UE based on the RACH message received at 604. The determination may be based on an eRedCap indication provided by the RACH message similar to that described above with respect to FIG. 5 or elsewhere herein.

The operational flow/algorithmic structure 600 may further include, at 612, scheduling resources within eRedCap limitations. For example, the base station 108 may restrict scheduling of PUSCH/PDSCH transmissions to PRB allocations that do not exceed 5 MHz. The base station 108 may restrict this scheduling at least until the base station receives a more complete set of UE capabilities at a later time.

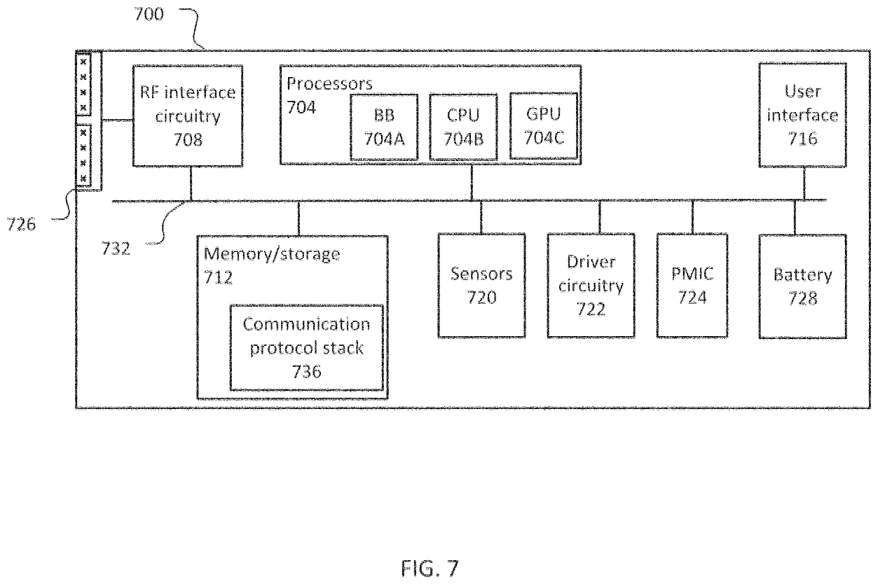

FIG. 7 illustrates a UE 700 in accordance with some embodiments. The UE 700 may be similar to and substantially interchangeable with UE 104 of FIG. 1.

The UE 700 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 700 may include processors 704, RF interface circuitry 708, memory/storage 712, user interface 716, sensors 720, driver circuitry 722, power management integrated circuit (PMIC) 724, antenna structure 726, and battery 728. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 732, which may represent any type of interface, input/output, bus (local, system, or expansion), transmission line, trace, or optical connection that allows various circuit components (on common or different chips or chipsets) to interact with one another.

The processors 704 may include processor circuitry such as, for example, baseband processor circuitry (BB) 704A, central processor unit circuitry (CPU) 704B, and graphics processor unit circuitry (GPU) 704C. The processors 704 may include any type of circuitry or processor circuitry that executes or otherwise operates computer-executable instructions, such as program code, software modules, or functional processes from memory/storage 712 to cause the UE 700 to perform operations as described herein.

In some embodiments, the baseband processor circuitry 704A may access a communication protocol stack 736 in the memory/storage 712 to communicate over a 3GPP compatible network. In general, the baseband processor circuitry 704A may access the communication protocol stack 736 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 708.

The baseband processor circuitry 704A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 712 may include one or more non-transitory, computer-readable media that includes instructions (for example, communication protocol stack 736) that may be executed by one or more of the processors 704 to cause the UE 700 to provide an eRedCap notification through an RA procedure as described herein. For example, the processors 704 may cause the UE to perform the operational flow/algorithmic structure 500 or any other method or process describe herein.

The memory/storage 712 include any type of volatile or non-volatile memory that may be distributed throughout the UE 700. In some embodiments, some of the memory/storage 712 may be located on the processors 704 themselves (for example, L1 and L2 cache), while other memory/storage 712 is external to the processors 704 but accessible thereto via a memory interface. The memory/storage 712 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 708 may include transceiver circuitry and radio frequency front module (RFEM) that allows the UE 700 to communicate with other devices over a radio access network. The RF interface circuitry 708 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 726 and proceed to filter and amplify (with a low-noise amplifier) the signal. The signal may be provided to a receiver of the transceiver that down-converts the RF signal into a baseband signal that is provided to the baseband processor of the processors 704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 726.

In various embodiments, the RF interface circuitry 708 may be configured to transmit/receive signals in a manner compatible with NR access technologies.

The antenna structure 726 may include antenna elements to convert electrical signals into radio waves to travel through the air and to convert received radio waves into electrical signals. The antenna elements may be arranged into one or more antenna panels. The antenna structure 726 may have antenna panels that are omnidirectional, directional, or a combination thereof to enable beamforming and multiple input, multiple output communications. The antenna structure 726 may include microstrip antennas, printed antennas fabricated on the surface of one or more printed circuit boards, patch antennas, or phased array antennas. The antenna structure 726 may have one or more panels designed for specific frequency bands including bands in FR1 or FR2.

The user interface 716 includes various input/output (I/O) devices designed to enable user interaction with the UE 700. The user interface 716 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 700.

The sensors 720 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 722 may include software and hardware elements that operate to control particular devices that are embedded in the UE 700, attached to the UE 700, or otherwise communicatively coupled with the UE 700. The driver circuitry 722 may include individual drivers allowing other components to interact with or control various I/O devices that may be present within, or connected to, the UE 700. For example, the driver circuitry 722 may include circuitry to facilitate coupling of a UICC (for example, UICC 78) to the UE 700. For additional examples, driver circuitry 722 may include a display driver to control and allow access to a display device, a touchscreen driver to control and allow access to a touchscreen interface, sensor drivers to obtain sensor readings of sensors 720 and control and allow access to sensors 720, drivers to obtain actuator positions of electro-mechanic components or control and allow access to the electro-mechanic components, a camera driver to control and allow access to an embedded image capture device, audio drivers to control and allow access to one or more audio devices.

The PMIC 724 may manage power provided to various components of the UE 700. In particular, with respect to the processors 704, the PMIC 724 may control power-source selection, voltage scaling, battery charging, or DC-to-DC conversion.

In some embodiments, the PMIC 724 may control, or otherwise be part of, various power saving mechanisms of the UE 700 including DRX as discussed herein.

A battery 728 may power the UE 700, although in some examples the UE 700 may be mounted deployed in a fixed location, and may have a power supply coupled to an electrical grid. The battery 728 may be a lithium ion battery, a metal-air battery, such as a zinc-air battery, an aluminum-air battery, a lithium-air battery, and the like. In some implementations, such as in vehicle-based applications, the battery 728 may be a typical lead-acid automotive battery.

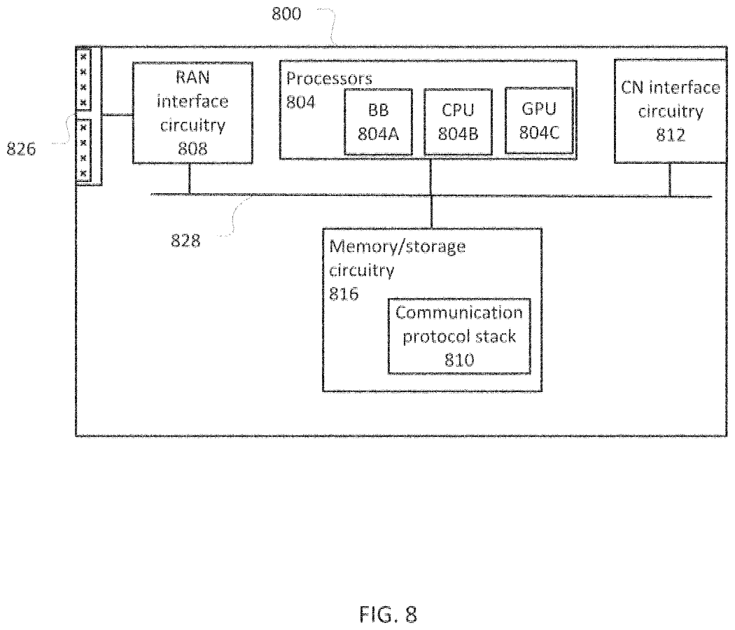

FIG. 8 illustrates a network node 800 in accordance with some embodiments. The network node 800 may be similar to and substantially interchangeable with base station 108.

The network node 800 may include processors 804, RF interface circuitry 808 (if implemented as an access node), core network (CN) interface circuitry 812, memory/storage circuitry 816, and antenna structure 826.

The components of the network node 800 may be coupled with various other components over one or more interconnects 828.

The processors 804, RF interface circuitry 808, memory/storage 816 (including communication protocol stack 810), antenna structure 826, and interconnects 828 may be similar to like-named elements shown and described with respect to FIG. 7.

The memory/storage 816 may include one or more non-transitory, computer-readable media that includes instructions (for example, communication protocol stack 810) that may be executed by one or more of the processors 804 to cause the network node 800 to identify and schedule eRedCap UEs described herein. For example, the processors 804 may cause the network node 800 to perform the operational flow/algorithmic structure 600 or any other method or process describe herein.

The CN interface circuitry 812 may provide connectivity to a core network, for example, a 5th Generation Core network (5GC) using a 5GC-compatible network interface protocol such as carrier Ethernet protocols, or some other suitable protocol. Network connectivity may be provided to/from the network node 800 via a fiber optic or wireless backhaul. The CN interface circuitry 812 may include one or more dedicated processors or FPGAs to communicate using one or more of the aforementioned protocols. In some implementations, the CN interface circuitry 812 may include multiple controllers to provide connectivity to other networks using the same or different protocols.

In some embodiments, the network node 800 may be coupled with transmit receive points (TRPs) using the antenna structure 826, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method of operating a user equipment (UE), the method comprising: generating a random-access channel (RACH) message; and transmitting the RACH message to a base station, wherein transmitting the RACH message to the base station is to indicate the UE is operating as an enhanced reduced capability (eRedCap) UE having an uplink (UL) shared channel (SCH) bandwidth no greater than five megahertz (MHz).

Example 2 includes the method of example 1 or some other example herein, wherein RACH message includes a value in a logical channel identifier (LCID) field of a media access control (MAC) subheader, wherein the value is to indicate the UE is operating as the eRedCap UE.

Example 3 includes method of example 2 or some other example herein, wherein the value in the LCID field further indicates that a common control channel (CCCH) has a size of 48 bits or 64 bits.

Example 4 includes a method of example 1 or some other example herein, further comprising: receiving, from the base station, a random access response that schedules uplink resources; and transmitting the RACH message using the uplink resources.

Example 5 includes a method of example 4 some other example herein, further comprising: performing a contention-based random-access (CBRA) procedure by receiving the random access response and transmitting the RACH message.

Example 6 includes the method of example 1 or some other example herein, further comprising: receiving from the base station, a random access (RA) preamble assignment message with an RA preamble, wherein the RACH message is a random-access request that includes the RA preamble.

Example 7 includes the method of example 6 or some other example herein, further comprising: performing a contention-free random-access (CFRA) procedure by receiving the RA preamble assignment message and transmitting the random-access request.

Example 8 includes a method of example 1 or some other example herein, wherein the RACH message includes a random-access (RA) preamble and the method further comprises: receiving a configuration of RACH resources to be used by eRedCap UEs; and transmitting the RA preamble using the RACH resources to indicate the UE is operating as the eRedCap UE.

Example 9 includes the method of example 8 or some other example herein, wherein the RACH resources comprise a RACH partition configured with a plurality of RA preambles that are to be used by eRedCap UEs, wherein the RACH message includes an RA preamble of the plurality of RA preambles.

Example 10 includes a method of example 9 or some other example herein, the configuration of RACH resources comprises: a feature combination information element (IE) and a feature combination preambles IE.

Example 11 includes a method of example 8 or some other example herein, wherein the RACH resources comprise physical RACH (PRACH) resources dedicated to eRedCap UEs and the configuration of the PRACH resources comprises a bandwidth part uplink common information element (IE).

Example 12 includes a method of example 8 or some other example herein, further comprising: receiving, from the base station, a system information broadcast (SIB) message with an instruction to provide an eRedCap indication in a message 1 (Msg1) RACH transmission or a message 3 (Msg3) RACH transmission.

Example 13 includes a method of operating a base station, the method comprising: receiving, from a user equipment (UE), a random-access channel (RACH) message; determining, based on the RACH message, that the UE is operating as an enhanced reduced capability (eRedCap) UE having an uplink (UL) shared channel (SCH) bandwidth no greater than five megahertz (MHz); and scheduling uplink or downlink resources for the UE based on said determining the UE is operating as an eRedCap UE.

Example 14 includes a method of example 13 or some other example herein, wherein RACH message includes a value in a logical channel identifier (LCID) field of a media access control (MAC) subheader, wherein the value is to indicate the UE is operating as the eRedCap UE.

Example 15 includes the method of example 14 or some other example herein, wherein the value in the LCID field further indicates that a common control channel (CCCH) has a size of 48 bits or 64 bits.

Example 16 includes the method of example 13 or some other example herein, further comprising: configuring a bandwidth part with an eRedCap indication process, wherein the eRedCap indication process is based on a logical channel identifier, a RACH partition, or physical RACH (PRACH) resources.

Example 17 includes the method of example 16 or some other example herein, further comprising: configuring a plurality of BWPs with a respective plurality of eRedCap indication processes.

Example 18 includes the method of example 13 or some other example herein, wherein the RACH message includes a random-access (RA) preamble and the method further comprises: providing, to the UE, a configuration of RACH resources to be used by eRedCap UEs; receiving the RACH message on the RACH resources; and determining the UE is operating as the eRedCap UE based on receiving the RACH message on the RACH resources.

Example 19 includes the method of example 18 or some other example herein, wherein the RACH resources comprise a RACH partition and the configuration is provided in a feature combination information element.

Example 20 includes the method of example 18 or some other example herein, wherein the RACH resources comprise physical RACH (PRACH) resources dedicated to eRedCap UEs and the configuration is provided in a bandwidth part configuration information element.

Example 21 includes a method of example 13 or some other example herein, further comprising: transmitting a system information broadcast (SIB) message with an instruction to provide an eRedCap indication in a message 1 (Msg1) RACH transmission or a message 3 (msg3) RACH transmission.

Another example may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Another example may include an apparatus comprising logic, modules, or circuitry to perform one or more elements of a method described in or related to any of examples 1-21, or any other method or process described herein.

Another example may include a method, technique, or process as described in or related to any of examples 1-21, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-21, or portions thereof.

Another example include a signal as described in or related to any of examples 1-21, or portions or parts thereof.

Another example may include a datagram, information element, packet, frame, segment, PDU, or message as described in or related to any of examples 1-21, or portions or parts thereof, or otherwise described in the present disclosure.

Another example may include a signal encoded with data as described in or related to any of examples 1-21, or portions or parts thereof, or otherwise described in the present disclosure.

Another example may include a signal encoded with a datagram, IE, packet, frame, segment, PDU, or message as described in or related to any of examples 1-21, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-21, or portions thereof.

Another example may include a computer program comprising instructions, wherein execution of the program by a processing element is to cause the processing element to carry out the method, techniques, or process as described in or related to any of examples 1-21, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-21. (canceled)

22. At least one non-transitory, computer-readable media having instructions that, when executed, cause processor circuitry to:
generate a random-access channel (RACH) message; and
output the RACH message for transmission to a base station to indicate a user equipment (UE) is operating as an enhanced reduced capability (eRedCap) UE having an uplink (UL) shared channel (SCH) bandwidth no greater than five megahertz (MHz).

23. The at least one non-transitory, computer-readable media of claim 22, wherein RACH message includes a value in a logical channel identifier (LCID) field of a media access control (MAC) subheader, wherein the value is to indicate the UE is operating as the eRedCap UE,
wherein the value in the LCID field further indicates that a common control channel (CCCH) has a size of 48 bits or 64 bits.

24. The at least one non-transitory, computer-readable media of claim 22, wherein the instructions, when executed, further cause the processor circuitry to:
receive, from the base station, a random access response that schedules uplink resources;
output the RACH message for transmission using the uplink resources; and
perform a contention-based random-access (CBRA) procedure by receiving the random access response and transmitting the RACH message.

25. The at least one non-transitory, computer-readable media of claim 22, wherein the instructions, when executed, further cause the processor circuitry to:
receive from the base station, a random access (RA) preamble assignment message with an RA preamble, wherein the RACH message is a random-access request that includes the RA preamble; and
perform a contention-free random-access (CFRA) procedure by receiving the RA preamble assignment message and transmitting the random-access request.

26. The at least one non-transitory, computer-readable media of claim 22, wherein the RACH message includes a random-access (RA) preamble and the instructions, when executed, further cause the processor circuitry to:
receive a configuration of RACH resources to be used by eRedCap UEs; and
output the RA preamble for transmission using the RACH resources to indicate the UE is operating as the eRedCap UE.

27. The at least one non-transitory, computer-readable media of claim 26, wherein the RACH resources comprise a RACH partition configured with a plurality of RA preambles that are to be used by eRedCap UEs, wherein the RACH message includes an RA preamble of the plurality of RA preambles, and the configuration of RACH resources includes: a feature combination information element (IE) and a feature combination preambles IE.

28. The at least one non-transitory, computer-readable media of claim 26, wherein the RACH resources comprise physical RACH (PRACH) resources dedicated to eRedCap UEs and the configuration of the PRACH resources comprises a bandwidth part uplink common information element (IE).

29. The at least one non-transitory, computer-readable media of claim 26, wherein the instructions, when executed, further cause the processor circuitry to:
receive, from the base station, a system information broadcast (SIB) message with an instruction to provide an eRedCap indication in a message 1 (Msg1) RACH transmission or a message 3 (Msg3) RACH transmission.

30. A method for wireless communication, the method comprising:
generating a random-access channel (RACH) message; and
outputting the RACH message for transmission to a base station to indicate a user equipment (UE) is operating as an enhanced reduced capability (eRedCap) UE having an uplink (UL) shared channel (SCH) bandwidth no greater than five megahertz (MHz).

31. The method of claim 30, wherein RACH message includes a value in a logical channel identifier (LCID) field of a media access control (MAC) subheader, wherein the value is to indicate the UE is operating as the eRedCap UE.

32. The method of claim 30, further comprising:
receiving, from the base station, a random access response that schedules uplink resources; and
outputting the RACH message for transmission using the uplink resources.

33. The method of claim 30, further comprising:
receiving from the base station, a random access (RA) preamble assignment message with an RA preamble,
wherein the RACH message is a random-access request that includes the RA preamble.

34. A method of wireless communication, the method comprising:
receiving, from a user equipment (UE), a random-access channel (RACH) message;
determining, based on the RACH message, that the UE is operating as an enhanced reduced capability (eRedCap) UE having an uplink (UL) shared channel (SCH) bandwidth no greater than five megahertz (MHz); and
scheduling uplink or downlink resources for the UE based on said determining the UE is operating as an eRedCap UE.

35. The method of claim 34, wherein RACH message includes a value in a logical channel identifier (LCID) field of a media access control (MAC) subheader, wherein the value is to indicate the UE is operating as the eRedCap UE.

36. The method of claim 35, wherein the value in the LCID field further indicates that a common control channel (CCCH) has a size of 48 bits or 64 bits.

37. The method of claim 34, further comprising:
configuring a bandwidth part with an eRedCap indication process, wherein the eRedCap indication process is based on a logical channel identifier, a RACH partition, or physical RACH (PRACH) resources; and
configuring a plurality of BWPs with a respective plurality of eRedCap indication processes.

38. The method of claim 34, wherein the RACH message includes a random-access (RA) preamble and the method further comprises:
providing, to the UE, a configuration of RACH resources to be used by eRedCap UEs;
receiving the RACH message on the RACH resources; and
determining the UE is operating as the eRedCap UE based on receiving the RACH message on the RACH resources.

39. The method of claim 38, wherein the RACH resources comprise a RACH partition and the configuration is provided in a feature combination information element.

40. The method of claim 38, wherein the RACH resources comprise physical RACH (PRACH) resources dedicated to eRedCap UEs and the configuration is provided in a bandwidth part configuration information element.

41. The method of claim 34, further comprising:
outputting, for transmission, a system information broadcast (SIB) message with an instruction to provide an eRedCap indication in a message 1 (Msg1) RACH transmission or a message 3 (msg3) RACH transmission.
